(19) United States
(12) Patent Application Publication
(10) Pub. No.: US 2008/0143546 A1
(43) Pub. Date: Jun. 19, 2008

(54) LOCATING SYSTEM AND METHOD

(75) Inventor: Borje Rantala, Helsinki (FI)

Correspondence Address: PETER VOGEL;GE HEALTHCARE, 3000 N. GRANDVIEW BLVD., SN-477, WAUKESHA, WI, 53188, US

(73) Assignee: GENERAL ELECTRIC COMPANY, Schenectady, NY (US)

(21) Appl. No.: 11/612,034

(22) Filed: Dec. 18, 2006

(51) Int. Cl. G08B 21/00; H05B 41/36

(52) U.S. Cl. 340/686.1; 315/308

(57) ABSTRACT

A hospital location system is disclosed herein. The hospital location system includes a lighting system adapted for the illumination of the hospital, and a controller operatively connected to the lighting system. The controller is adapted to modulate the illumination from the lighting system in a predetermined manner. The hospital location system also includes a sensor configured to sense the illumination from the lighting system. The hospital location system is adapted to identify the location of the sensor based on the manner in which the illumination is modulated. A corresponding method for locating individuals and objects that are within or in close proximity to a hospital is also provided.

### FIELD OF THE INVENTION

This invention pertains generally to a locating system and method adapted for locating individuals and objects within or in close proximity to a hospital.

### BACKGROUND OF THE INVENTION

Hospitals generally have one or more lighting system adapted to selectively illuminate the facility. Traditional lighting systems include fluorescent and/or incandescent devices such as, for example, ceiling mounted light fixtures and lamps. Some modern hospitals implement light emitting diode (LED) lighting systems as an inexpensive and energy efficient alternative to more conventional lighting systems.

It is generally desirable to know the location of patients, hospital staff members, medical devices and other objects in a hospital. Automated location systems have therefore been developed to facilitate the process of locating individuals and/or objects in a hospital. Location systems implemented in a hospital environment typically incorporate infra-red (IR) technology.

One problem is that many hospitals do not have automated location system such that the process of locating an individual or object must be manually performed. Manually performed locating processes are inherently inefficient and time consuming.

Another problem pertains to conventional automated location systems. The automated location systems are typically dedicated systems adapted exclusively for the purpose of tracking and locating. The problem is that hospitals necessarily incorporate multiple systems (one for illumination and another for location) which incurs additional expense.

### SUMMARY OF THE INVENTION

The above-mentioned shortcomings, disadvantages and problems are addressed herein which will be understood by reading and understanding the following specification.

In an embodiment, a hospital location system includes a lighting system adapted for the illumination of the hospital, and a controller operatively connected to the lighting system. The controller is adapted to modulate the illumination from the lighting system in a predetermined manner. The hospital location system also includes a sensor configured to sense the illumination from the lighting system. The hospital location system is adapted to identify the location of the sensor based on the manner in which the illumination is modulated.

In another embodiment, a hospital location system includes a plurality of lighting systems configured to respectively illuminate a plurality of hospital regions. A controller is operatively connected to the plurality of lighting systems. The controller is adapted to modulate the illumination from the plurality of lighting systems to provide a corresponding plurality of illumination patterns. A sensor is configured to sense one of the illumination patterns. The sensor includes a transmitter configured to send a signal identifying the sensed illumination pattern. The location system also includes a computer adapted to receive the signal from the transmitter. The computer is configured to locate the sensor relative to the plurality of hospital regions based on the signal. The hospital location system provides a single cost efficient system for both location and illumination.

In yet another embodiment, a method for locating individuals and objects that are within or in close proximity to a hospital includes providing a lighting system adapted to illuminate the hospital, modulating the illumination from the lighting system in a predetermined manner, and sensing the illumination from the lighting system. The method for locating also includes identifying the location of the sensor based on the manner in which the illumination is modulated.

Various other features, objects, and advantages of the invention will be made apparent to those skilled in the art from the accompanying drawings and detailed description thereof.

### BRIEF DESCRIPTION OF THE DRAWINGS

FIG. 1 is a schematic diagram of a location system in accordance with an embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

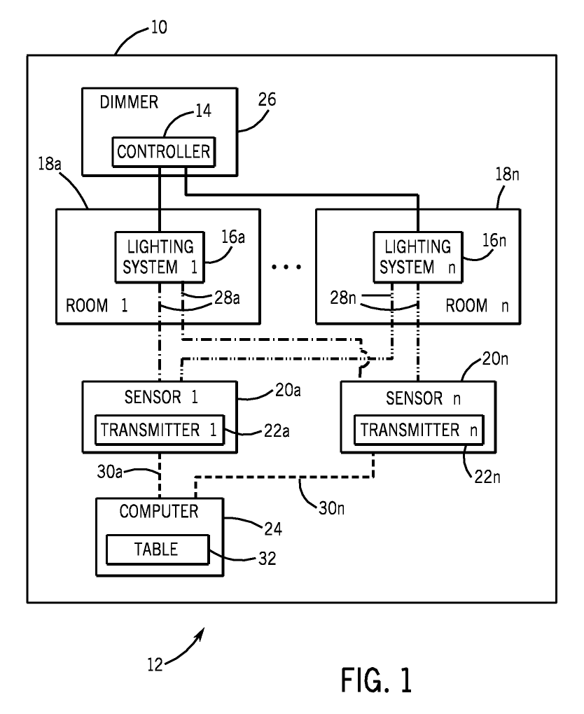

Referring to FIG. 1, a locating system 10 for a hospital 12 is shown in accordance with an embodiment. The locating system 10 includes a controller 14 operatively connected to a plurality of lighting systems 16a-16n respectively disposed in a plurality of rooms 18a-18n. As will be described in more detail hereinafter, the locating system 10 can implement a hospital's pre-existing lighting systems such that the hospital can locate individuals and/or objects without the expense associated with providing a separate location system. Therefore, a hospital can inexpensively and efficiently be updated to incorporate location technology with the locating system 10. The controller 14 may include any known device adapted to independently regulate the operation of the lighting systems 16a-16n.

The lighting systems 16a-16n may include all or a portion of the illumination sources for a corresponding room 18a-18n, and may include known illumination devices such as, for example, light fixtures and lamps. According to one embodiment, the lighting systems 16a-16n may incorporate light emitting diodes (LEDs). According to another embodiment, the lighting systems 16a-16n may incorporate incandescent lights. While the locating system 10 will hereinafter be described according to an embodiment wherein the lighting systems 16a-16n are respectively disposed in the rooms 18a-18n, it should be appreciated that alternate embodiments may incorporate additional lighting systems (not shown) into other parts of the hospital 12 such as a hallway, lobby, parking structure, etc.

A plurality of sensors 20a-20n are adapted to identify the presence, the intensity, and/or the frequency of light from the lighting systems 16a-16n. According to one embodiment, the sensors 20a-20n each include a conventional light sensor and one of the transmitters 22a-22n, respectively. The transmitters 22a-22n may each include a wireless device adapted to wirelessly transmit one of the signals 30a-30n to a computer 24, or alternatively the transmitters 22a-22n may be coupled to the computer 24 with wires (not shown). The sensors 20a-20n are attachable to individuals (e.g., patients or hospital staff members) or objects (e.g., medical equipment). The number of lighting systems 16a-16n and the number of sensors 20a-20n are not necessarily related. According to one embodiment, one or more of the sensors 20a-20n can be integrally incorporated with or attached to a physiological monitor such as a pulse oximeter thereby providing a single device adapted to both monitor and locate a patient. Advantageously, conventional pulse oximeter devices include a photo detector that can easily be adapted to perform the primary function of the sensors 20a-20n.

Having described the apparatus of the locating system 10 in accordance with an exemplary embodiment, the operation of the locating system 10 will now be described in more detail. The controller 14 is configured to modulate the emission of light or illumination from each of the lighting systems 16a-16n in a manner that defines a plurality of unique illumination patterns 28a-28n schematically depicted in FIG. 1. The modulation of illumination may include flashing the lights completely off and then back on, or varying the brightness or intensity of illumination such as with a dimmer 26. The controller 14 may be integrated into the dimmer 26 in order to minimize the number of components and to facilitate the process of controlling the lighting systems 16a-16n.

According to the embodiment wherein the lighting systems 16a-16n include LEDs, the lights can be flashed off and on at a rate that is fast enough to become imperceptible to humans. According to the embodiment wherein the lighting systems 16a-16n include incandescent lights, the lights can be modulated between frequencies that are imperceptible to humans. Therefore, the locating system 10 can produce the illumination patterns 28a-28n in a manner that does not noticeably impact the occupants of the rooms 18a-18n. Additionally, the locating system 10 can produce the illumination patterns 28a-28n regardless of whether or not the rooms 18a-18n are actually being illuminated by the lighting systems 18a-18n. As an example, if the occupant of a room chooses to turn off their lighting system in order to sleep, the locating system 10 can flash the lights quickly enough or at a low enough frequency to maintain the appearance of complete darkness.

The sensor 20a will hereinafter be described in detail for exemplary purposes. It should, however, be appreciated that the sensors 20b-20n function similarly to the sensor 20a. The sensor 20a is adapted to sense any illumination pattern 28a-28n to which it is exposed. Therefore, if the sensor 20a is in room 18a, it will sense the illumination pattern 28a. Similarly, if the sensor 20a is in room 18n, it will sense the illumination pattern 28n. When the sensor 20a senses one of the illumination patterns 28a-28n, the transmitter 22a sends a signal 30a to the computer. For illustrative purposes, the subsequent discussion assumes the sensor 20a is in room 18a such that that the sensed illumination pattern is 28a. It should, however, be appreciated that the sensed illumination pattern may include any of the illumination patterns 28a-28n depending on the room in which the sensor 20a is located. The signal 30a is adapted to convey the sensed illumination pattern 28a to the computer 24.

When the computer 24 receives the signal 30a from the sensor 20a, the computer 24 is configured to identify the sensed illumination pattern 28a and the corresponding room 18a. According to one embodiment, the computer 24 includes a record or table 32 comprising each of the rooms 18a-18n and their respective illumination patterns 28a-28n so that the computer 24 can identify a room based on a sensed illumination pattern.

The sensors 20a-20n are attached to a plurality of individuals and objects within or near the hospital 12. The computer generally continuously receives a plurality of signals 30a-30n from the plurality of sensors 20a-20n. As previously described, the signals 30a-30n convey information that can be used to determine the particular room in which a given sensor 20a-20n is disposed at any given time. Therefore, by accessing the computer 24, an individual or object to which a given sensor 20a-20n is attached can be located relative to one of the rooms 18a-18n. As previously indicated, one or more additional lighting systems (not shown) can be disposed in other regions of the hospital 12 (e.g., a hallway or lobby) including regions outside but in relatively close proximity to the hospital 12 (e.g., hospital parking structure). Therefore, an individual or object to which a given sensor 20a-20n is attached may also be located relative to any such hospital region incorporating one or more additional lighting systems.\

According to one embodiment, the dimmer 26 may represent a plurality of dimmers that are each adapted to modulate the emission of light from one of the lighting systems 16a-16n. Each dimmer could be assigned a unique dimmer code or dimmer ID that is conveyed through an illumination pattern 28a-28n. The particular illumination pattern 28a-28n that was sensed by one of the sensors 20a-20n can then be automatically transmitted to the computer 24 or, if the dimmer 26 does not include a computer port, the sensed illumination pattern 28a-28n can be manually input into the computer 24. In this manner, the computer 24 can identify the specific room 18a-18n in which a given sensor 20a-20n resides by cross-referencing a sensed illumination pattern 28a-28n with its corresponding room 18a-18n. This embodiment implements the dimmer 26 to serve a primary function of the controller 14 (i.e., modulation of emitted light), and is therefore particularly well adapted for use in hospitals that do not have a lighting controller 14 and do not want to incur the expense of adding a lighting controller 14.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

I claim:

1. A hospital location system comprising:
a lighting system adapted for the illumination of the hospital;
a controller operatively connected to the lighting system, said controller adapted to modulate the illumination from the lighting system in a predetermined manner; and
a sensor configured to sense the illumination from the lighting system;
wherein the hospital location system is adapted to identify the location of the sensor based on the manner in which the illumination is modulated.

2. The hospital location system of claim 1, wherein said lighting system includes light emitting diodes.

3. The hospital location system of claim 1, wherein said lighting system includes incandescent lights.

4. The hospital location system of claim 1, wherein said controller is adapted to modulate the illumination from the lighting system in a manner that is imperceptible to humans.

5. The hospital location system of claim 1, wherein said controller is incorporated into a dimmer operatively connected to the lighting system, said dimmer adapted to selectively regulate the intensity of the illumination.

6. The hospital location system of claim 1, wherein said sensor is integrated into a physiological monitoring device.

7. The hospital location system of claim 1, wherein said sensor includes a transmitter.

8. The hospital location system of claim 7, further comprising a computer wirelessly coupled with the transmitter.

9. A hospital location system comprising:
a plurality of lighting systems configured to respectively illuminate a plurality of hospital regions;
a controller operatively connected to the plurality of lighting systems, said controller adapted to modulate the illumination from the plurality of lighting systems to provide a corresponding plurality of illumination patterns;
a sensor configured to sense one of the plurality of illumination patterns, said sensor including a transmitter configured to send a signal identifying said one of the plurality of illumination patterns; and
a computer adapted to receive the signal from the transmitter, said computer configured to locate the sensor relative to the plurality of hospital regions based on the signal;
wherein the hospital location system provides a single cost efficient system for both location and illumination.

10. The hospital location system of claim 9, wherein said plurality of lighting systems include light emitting diodes.

11. The hospital location system of claim 9, wherein said plurality of lighting systems include incandescent lights.

12. The hospital location system of claim 9, wherein said controller is adapted to modulate the illumination from the plurality of lighting systems in a manner that is imperceptible to humans.

13. The hospital location system of claim 9, wherein said controller is incorporated into a dimmer operatively connected to the plurality of lighting systems.

14. The hospital location system of claim 9, wherein said sensor is integrated into a physiological monitoring device.

15. A method for locating individuals and objects that are within or in close proximity to a hospital:
providing a lighting system adapted to illuminate the hospital;
modulating the illumination from the lighting system in a predetermined manner;
sensing the illumination from the lighting system; and
identifying the location of the sensor based on the manner in which the illumination is modulated.

16. The method of claim 15, wherein said modulating the illumination from the lighting system includes turning the lighting system off and on.

17. The method of claim 15, wherein said modulating the illumination from the lighting system includes varying the frequency of the illumination.

18. The method of claim 15, wherein said modulating the illumination from the lighting system includes modulating the illumination in a manner that is imperceptible to humans.

19. The method of claim 15, wherein said modulating the illumination from the lighting system includes modulating the illumination with a dimmer in a manner adapted to convey a dimmer code.

20. The method of claim 19, wherein said identifying the location of the sensor includes manually inputting the dimmer code into a computer.
